(19) United States
(12) Patent Application Publication
(10) Pub. No.: US 2010/0222719 A1
(43) Pub. Date: Sep. 2, 2010

(54) Deep Acting Topically Working Facial Care Appliance

(76) Inventors: Ross Cowie, Ottawa (CA); Rudy Vandenbelt, Ottawa (CA)

Correspondence Address: LAW OFFICE OF A.P. DURIGON, 20 EUSTIS STREET, CAMBRIDGE, MA, 02140, US

(21) Appl. No.: 12/395,923

(22) Filed: Mar. 2, 2009

(51) Int. Cl. A61H 1/00; A61H 7/00

(52) U.S. Cl. 601/46; 601/135; 601/112

(57) ABSTRACT

A deep acting topically working facial care appliance includes a dual action facial puck having a rotating and counter rotatable facial implement that is dually effective both to clean, massage, apply compositions and otherwise topically work the skin and to deeply act to penetrate below the epidermis and into the dermis massaging and deeply passivating and enervating the dermis and dermal collagen.

### FIELD OF THE INVENTION

This invention is drawn to the field of facial care products, and more particularly, to a novel, deep acting topically working facial care appliance.

### BACKGROUND OF THE INVENTION

A regimen of cleaning the skin and applying toners, moisturizing and other agents, and facial massage, contributes to a good complexion and overall facial beauty. While these and other steps have traditionally been manually performed, there is a growing use of facial care appliances by individuals in their daily facial care regimen and at health and beauty spas in the effort to provide and promote a clean, firm, healthy and radiant looking skin and face.

Facial care appliances having purely rotary action attachments are generally good for cleansing the face. They use a rotary brush or rotary sponge and a cleaning agent to clean and/or exfoliate the cheeks, forehead and nose. However, the deep region under the skin is generally unaffected by the turning action of its rotary head as it cleans, exfoliates or otherwise topically treats the surface of the skin.

Facial care appliances having bristle heads vibrated at high, ultrasonic frequency are also generally effective at cleaning the face. But like their counterparts having purely rotary action attachments, the vibratory action at ultrasonic frequency of their tingling brush heads generally is topically effective and while reaching into pores leaves the dermal layer substantially unaffected.

There are also facial care appliances having buzzing drumheads vibrated back and forth by mechanical action. The mechanically vibrated buzzing drumheads may be used for massage alone or in combination with different disposable pads removably mounted to the buzzing drumheads for cleansing or otherwise topically treating the skin. The mechanically vibrated buzzing drumheads, however, primarily function as a vibrating massager but intrinsically provide limited topical action, its cleaning or other topically treating functions occurring principally by moving the buzzing drumheads as a whole about the face in a manner to scrub or apply some lotion for other composition to the skin.

There is thus a need to provide a facial care appliance enjoying all of the benefits of the heretofore known products while not being subject to their individual limitations.

### SUMMARY OF THE INVENTION

It accordingly is the principal object of the present invention to provide a deep acting, topically working facial care appliance that is dually effective both to clean, massage, apply compositions and otherwise topically work the skin and to deeply act to penetrate below the epidermis and into the dermis massaging and deeply passivating and enervating the dermis and dermal collagen.

It is a related object of the present invention to provide a deep acting topically working facial care appliance that is usable as part of a daily facial care regimen of cleansing, applying beauty preparations and/or massaging the skin and face to help provide clean, firm, healthy, radiant looking skin.

It is a related object of the present invention to provide a deep acting topically working facial care appliance that is safe to use in a daily facial care regimen.

In accord with these and other objects, the present invention discloses a deep acting topically working facial care appliance comprising a tubular body longitudinally extending between opposing forward and rear ends including a generally tubular handhold intermediate the ends of the tubular body for gripping the tubular body circumferentially about the direction of elongation of the tubular body, and, axially extending from and in-line with the tubular body, a dual action facial puck carried by and longitudinally extending from the forward end of the tubular body, the dual action facial puck including a first component subassembly including an orbiting, eccentric shaft and a second component subassembly including a facial implement rotatable about and rotating with the orbiting, eccentric shaft of the first component subassembly, the facial implement rotatable about and rotating with the orbiting, eccentric shaft is dually effective both to clean, massage, apply compositions and otherwise topically work the skin and to deeply act to penetrate below the epidermis and into the dermis massaging and deeply passivating and enervating the dermis and dermal collagen at the point of application of the dual action facial puck on the face.

The first component subassembly of the dual action facial puck preferably includes a main gear turned about an axis by a motor mounted intermediate the forward and rear ends at and about the center of gravity of the tubular body and an axle eccentrically carried by the main gear that is turned about the axis of the gear as the motor turns.

The second component subassembly of the dual action facial puck preferably includes a spinner rotatably mounted about the axle eccentrically carried by the main gear and a facial implement mounted for rotation with the spinner.

The first and the second component subassemblies of the dual action facial puck could be otherwise embodied without departing from the inventive concepts.

In one presently preferred embodiment, a snap-releasable end cap is removably mounted at the rear end of the tubular body of the deep acting topically working facial care appliance to provide easy access to a battery compartment interior to the tubular body to allow battery insertion and removal.

In the presently preferred embodiment, different snap-releasable facial implements for cleaning, topically applying facial compositions, and for massage are individually mounted for rotation with the spinner of the second component subassembly of the dual action facial puck.

### BRIEF DESCRIPTION OF THE DRAWINGS

These and other objects, inventive aspects and advantageous features of the present invention will become apparent as the invention becomes better understood by reference to the following, solely exemplary, detailed description of the presently preferred embodiments, and to the drawings, wherein:

FIG. 1 is an isometric view of the forward end of a deep acting topically working facial care appliance in accord with the present invention;

FIG. 2 is an exploded, isometric view showing different facial implements for cleansing, applying lotions or other facial compositions, and massaging the skin and face;

FIG. 3 is a fragmentary, partially exploded isometric view of the forward end of the deep acting topically working facial care appliance of the present invention; and

FIG. 4 is a partially schematic, partially pictorial diagram useful in explaining the operation of the deep acting topically working facial care appliance of the present invention.

### DETAILED DESCRIPTION OF THE PRESENTLY PREFERRED EMBODIMENTS

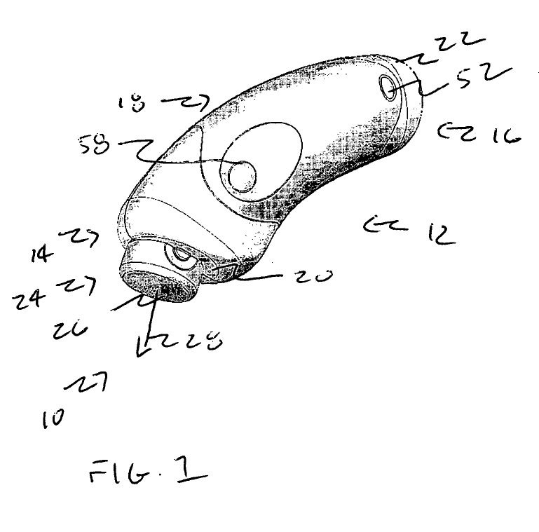

Referring now to FIG. 1, generally designated at 10 is an isometric view of the forward end of a deep acting topically working facial care appliance in accord with the present invention that is dually effective both to clean, massage, apply compositions and otherwise topically work the skin and to deeply act to penetrate below the epidermis and into the dermis massaging and deeply passivating and enervating the dermis and dermal collagen. When made a part of a regular daily facial care regimen of cleansing, applying beauty preparations and massaging the skin and face, the facial care appliance 10 is safe to use and helps to provide clean, firm, healthy, radiant looking skin.

The deep acting topically working facial care appliance 10 includes an elongated tubular body generally designated 12 having longitudinally opposed forward and rear ends generally designated 14, 16 and a handhold generally designated 18 intermediate the forward and rear ends 14, 16 adapted to be gripped between the palm and fingers of the hand circumferentially about the direction of elongation of the elongated tubular body 12.

The tubular body terminates in a flat interface 20 at its forward end 14 oriented generally transverse to the direction of elongation of the elongated tubular body 12. A battery cap 22 preferably is removably mounted at the rear end 16 of the tubular body 12 in a manner to be described.

A dual action facial puck generally designated 24 including a removable applicator implement 26 axially extends from the flat interface 20 and is carried at the forward end 14 of the tubular body 12. The dual action facial puck 24 is operated by a non-removable drive mechanism to be described, not shown, in such a way that the applicator implement 26 at its point of application on the skin of the face is dually effective both to topically massage and/or to topically apply lotion or other compositions and to deeply penetrate below the epidermis and into the dermis massaging and deeply passivating and enervating the dermis and dermal collagen.

By varying the axial load as schematically illustrated by load vector 28 applied at the point of application of the applicator implement 26 on the skin of the face, the relative contribution of the deep acting and topically working actions of the dual action facial puck 24 may be varied, from all deep acting massage and no topical working action to all topical working action and little or no deep acting massage, to select that balance of deep acting massage and topically working actions that may be right for each type of facial implement and phase of use.

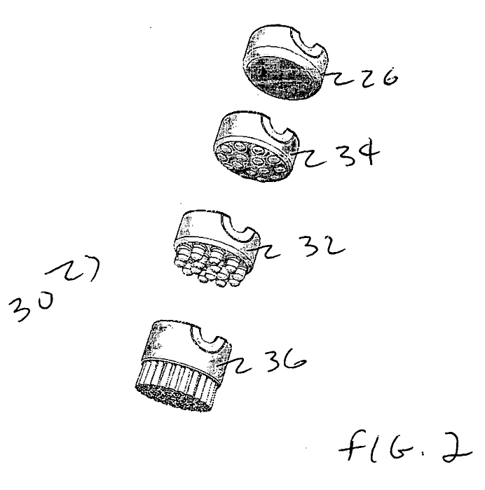

Referring now to FIG. 2, generally designated at 30 is an exploded isometric view showing different facial implements for cleansing, applying lotions or other facial compositions and massaging the skin and face in spaced apart relation. As shown, the different facial implements include a ribbed massage implement 32, a dimpled massage implement 34, the applicator implement 26 having a smooth surface suitable for applying lotions and other facial compositions and a cleansing brush implement 36. Of course, other types of facial implements may be employed, such as an eye cupping implement, not shown, and while the implements shown are generally circular, implements that have a generally elliptical, triangular or some other non-circular shape, may be employed.

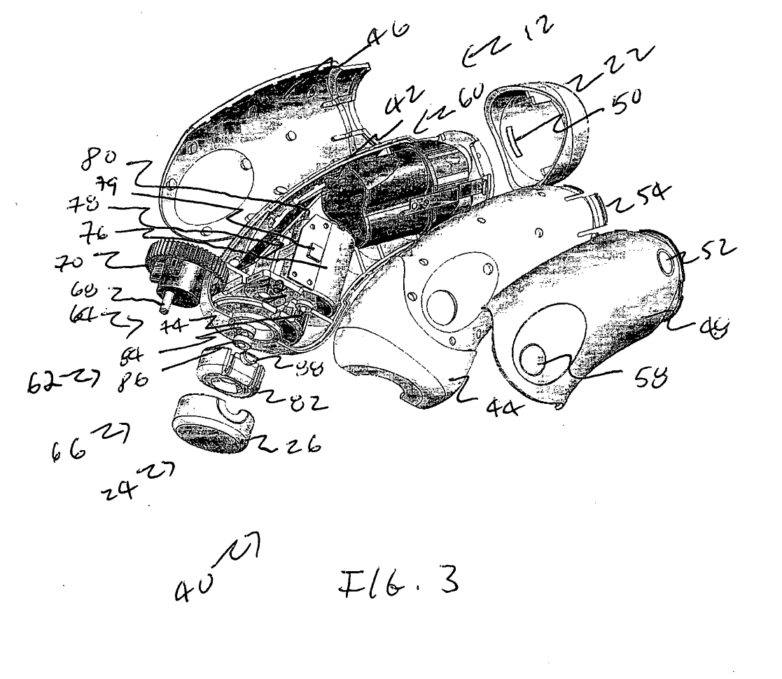

Referring now to FIG. 3, generally designated at 40 is a fragmentary, partially exploded isometric view of the forward end of the deep acting topically working facial care appliance of the present invention. The tubular body 12 of the facial care appliance 40 includes mating, inter-fitting semi-cylindrical sidewalls 42, 44 and outer skins 46, 48 respectively attached to the semi-cylindrical sidewalls 42, 44. The outer skins 46, 48 preferably are of rubber or other soft skin-like material that conforms in shape to sidewalls 42, 44 of the tubular housing body 12 and that is comfortable when palmed but also is slip resistant.

The battery cap 22 removably mounted to the rear end 16 of the tubular body 12 includes internal, opposing ledges 50 that are adapted to releasably engage longitudinally extending, opposing resilient fingers 54 respectively carried by the sidewalls 42, 44. The skins 46, 48 are dimpled as at 52, which, when pressed together, dislodges the fingers 54 from the ledges 50 thereby releasing the battery cap 22 from the rear end 16 of the tubular body 12 to expose a battery compartment generally designated 60 allowing for ease of battery insertion and removal.

Drive mechanism generally designated 62 includes an eccentrically rotating first component subassembly generally designated 64 and a concentrically rotating second component subassembly generally designated 66. The first component subassembly 64 includes axle 68 that is mounted for eccentric rotation to main gear 70. A counterweight, not shown, is provided in diametrically offset relation to the axle 68 to smooth the motion under conditions of no load. Although an eccentric axle 68 orbited by the main gear 70 is presently preferred, it will be appreciated that another mechanism such as the directly driven crank arm disclosed in U.S. Pat. No. 7,294,113 to Wu, dated Nov. 13, 2007, incorporated herein by reference, may be employed.

The main gear 70 of the first component subassembly 64 is mounted for rotary motion in a gearbox generally designated 72 carried by and between the sidewalls 42, 44 of the tubular body 12. The main gear 70 is driven by a drive gear 74 that is mounted for rotation with the shaft of a motor 76. The motor 76 is mounted in a motor box generally designated 78 carried by and between the sidewalls 42, 44 of the tubular body 12. The motor 76 is carried intermediate the forward and rear ends 14, 16 generally at and about the center of gravity of the tubular body 12.

A printed circuit card 80 carried by and between the sidewalls 42, 44 of the tubular body 12, and a switch, 79, carried by the sidewall 44 under a dimple 58 of outer skin 48, are operatively coupled to the motor 76 to turn it on and off and to controllably select its speed, preferably from low, medium and high speeds.

The second component subassembly 66 includes a spinner 82 journaled for rotation about the axle 68 of the main gear 70 by slip bearings 84, 86. The spinner 82 includes opposing, radially extending, resiliently biased release fingers 88 that removably mount the applicator implement 26 (or other facial implement) for rotation with the spinner 82. Although the second component subassembly 66 preferably includes the spinner 82 to which the different facial implements are individually mounted for rotation, a different means for mounting each facial implement for rotation with and about the axle 68 may be employed.

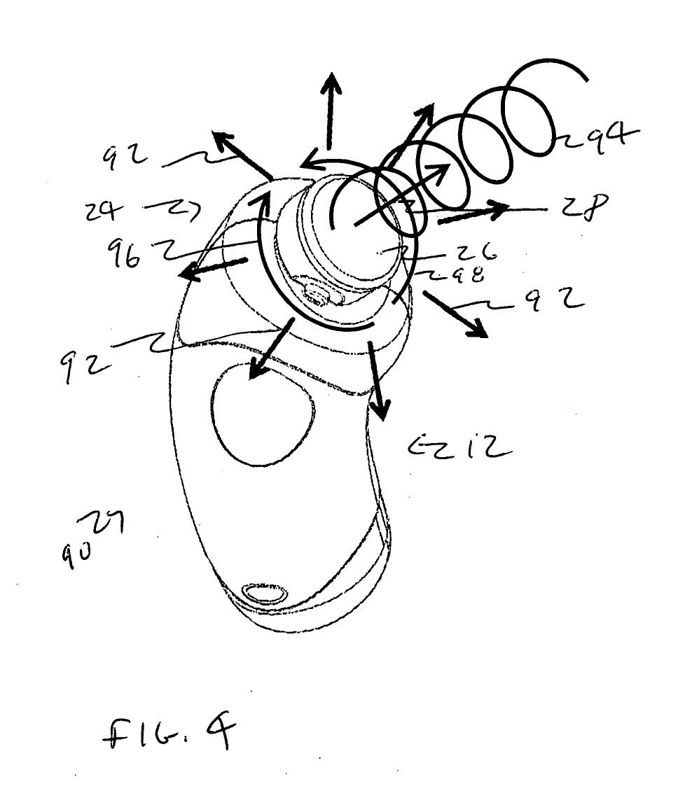

Referring now to FIG. 4, generally designated at 90 is a partially pictorial, partially schematic diagram useful in explaining the operation of the deep acting topically working facial care appliance of the present invention. The applicator implement 26 (or other facial implement) of the dual action facial puck 24 orbitally turns as the eccentric axle 68 (FIG. 3) is orbited by main gear 70 (FIG. 3), drive gear 74 (FIG. 3) and motor 76 (FIG. 3), rhythmically stretching and releasing the skin at its point of application on the face. Since the load vector 28 acts along the direction of elongation of the in-line facial puck 24 and tubular body 12, any off-axis force components transverse the load vector 28 induced by the eccentrically orbiting applicator implement as it rhythmically stretches and releases the skin are uniformly attenuated as schematically illustrated by equal-length arrows 92, producing at the point of application of the applicator implement 26 on the skin a homoeostatically balanced standing wave that deeply acts to penetrate below the epidermis and into the dermis massaging and deeply passivating and enervating the dermis and dermal collagen as schematically illustrated by spiral 94 without damaging the skin or face.

The applicator implement 26, which is mounted for rotation with the spinner 82 (FIG. 3), is rotated by and rotatable about the orbiting, eccentric axle 68 (FIG. 3). In dependence on the axial load 28, the applicator implement 26 (or other facial implement) topically swipes across the skin either clockwise or counterclockwise as schematically illustrated by arrows 96, 98 as the applicator implement rotates about the orbiting eccentric axle 68 (FIG. 3). The clockwise or counterclockwise rotations 96, 98 of the applicator attachment 26 are effective to topically work the skin in the application of lotions or other facial compositions, as well as to provide a topical massage action, as it swipes across the skin at the point of application of the dual action facial puck 24 on the face. As will be appreciated, the clockwise or counterclockwise rotations 96, 98 are effective to provide topical cleansing of the skin when the cleansing brush facial implement is employed, and to provide topical facial massage when either of the massage facial implements are employed.

Many modifications of the presently disclosed invention will become apparent to those of skill in the art without departing from the inventive concepts.

What is claimed is:

1. A facial appliance effective to clean, massage, apply compositions and otherwise topically treat the skin and effective to deeply penetrate below the epidermis and into the dermis massaging and deeply passivating and enervating the dermal collagen to provide clean, firm, healthy, radiant looking skin, comprising:
a tubular body longitudinally extending between opposing forward and rear ends including a generally tubular handhold intermediate the ends of the tubular body for gripping the tubular body circumferentially about the direction of elongation of the tubular body, and, axially extending from and in-line with the tubular body, a dual action facial puck carried by and longitudinally extending from the forward end of the tubular body, the dual action facial puck including a first component subassembly including an orbiting, eccentric shaft and a second component subassembly including a facial implement rotatable about and rotating with the orbiting, eccentric shaft of the first component subassembly, the facial implement of the dual action facial puck rotatable about and rotating with the orbiting, eccentric shaft is dually effective both to clean, massage, apply compositions and otherwise topically work the skin and to deeply act to penetrate below the epidermis and into the dermis massaging and deeply passivating and enervating the dermis and dermal collagen at the point of application of the dual action facial puck on the face.

2. The facial appliance of claim 1, wherein the first component subassembly of the dual action facial puck preferably includes a main gear turned about an axis by a motor mounted intermediate the forward and rear ends and generally at and about the center of gravity of the tubular body and an axle eccentrically carried by the main gear that is turned about the axis of the gear as the motor turns.

3. The facial appliance of claim 2, wherein the second component subassembly of the dual action facial puck includes a spinner rotatably mounted about the axle eccentrically carried by the main gear and wherein the facial implement is mounted for rotation with the spinner.

4. The facial appliance of claim 1, further including an end cap removably mounted at the rear end of the tubular body to allow battery insertion and removal to an interior battery compartment of the tubular body.

5. The facial appliance of claim 4, wherein the tubular body is comprised of mating, inter-fitting semi-cylindrical sidewalls and outer skins respectively attached to the sidewalls that conform in shape to the sidewalls of the tubular body and are comfortable when palmed as well as slip resistant.

6. The facial appliance of claim 5, wherein the end cap removably mounted at the rear end of the tubular body includes internal, opposing ledges that are adapted to releasably engage longitudinally extending, opposing resilient fingers respectively carried by the sidewalls.

7. The facial appliance of claim 1, wherein the facial puck is axially loaded at the point of application of the facial puck on the skin of the face and acts with a load vector that is directed along the direction of elongation of the in-line facial puck and tubular body.

8. The facial appliance of claim 1, wherein the facial implement is selected from the group of facial implements consisting of a cleansing implement, an applicator implement and a massage implement.

9. The facial appliance of claim 8, wherein the facial implement is a snap-releasable facial implement.
